(19) United States
(12) Patent Application Publication
(10) Pub. No.: US 2015/0025963 A1
(43) Pub. Date: Jan. 22, 2015

(54) METHOD AND SYSTEM FOR TARGETED CROWDSOURCING

(71) Applicant: THOMSON LICENSING, Issy de Moulineaux (FR)

(72) Inventors: Jean BOLOT, Los Altos, CA (US); Pedro Carvalho De Oliveira, Palo Alto, CA (US)

(21) Appl. No.: 13/944,110

(22) Filed: Jul. 17, 2013

(51) Int. Cl. G06Q 30/02; G06Q 50/00

(52) U.S. Cl. CPC G06Q 30/0251; G06Q 50/01
USPC 705/14.49

(57) ABSTRACT

A method and system are provided for targeted crowdsourcing. The method includes defining a target audience for a crowdsourcing task using fine-grain target audience parameters. At least one of the parameters is based on a user selection. The method further includes generating a targeted advertisement for a non-public landing page directed to the target audience. The method also includes generating the non-public landing page as a sole entry point for workers on the crowdsourcing task that is only visible to members of the target audience that click on the targeted advertisement. The method additionally includes permitting only members of the target audience that click on the targeted advertisement to proceed to the non-public landing page.

### TECHNICAL FIELD

The present principles relate generally to crowdsourcing and, more particularly, to a method and system for targeted crowdsourcing.

### BACKGROUND

Crowdsourcing and user targeting seems to be a very recent concern, and the focus so far seems to be more on targeting users for brand awareness or brand-related conversations.

A very common platform for crowdsourcing is the Amazon Mechanical Turk™ (AMT). AMT offers 4 types of targeting as follows: location (country-based); approval rate (only workers who had their previous tasks approved at least X % of the time); approval number (only workers who completed at least X tasks); and qualifications (workers who passed tests that make them qualified to do certain tasks, for example, tag images). However, AMT do not offer finer granularity targeting. Moreover, a key problem with crowdsourcing efforts is that often little (if anything) is known about the users doing the crowdsourcing work. This makes it hard to interpret results and feedback from crowdsourcing efforts.

### SUMMARY

These and other drawbacks and disadvantages of the prior art are addressed by the present principles, which are directed to a method and system for targeted crowdsourcing.

According to an aspect of the present principles, there is provided a method. The method includes defining a target audience for a crowdsourcing task using fine-grain target audience parameters. At least one of the parameters is based on a user selection. The method further includes generating a targeted advertisement for a non-public landing page directed to the target audience. The method also includes generating the non-public landing page as a sole entry point for workers on the crowdsourcing task that is only visible to members of the target audience that click on the targeted advertisement. The method additionally includes permitting only members of the target audience that click on the targeted advertisement to proceed to the non-public landing page.

According to another aspect of the present principles, a system is provided. The system includes a target audience definer for defining a target audience for a crowdsourcing task using fine-grain target audience parameters. At least one of the parameters is based on a user selection. The system further includes a targeted advertisement generator for generating a targeted advertisement for a non-public landing page directed to the target audience. The system also includes a non-public landing page generator for generating the non-public landing page as a sole entry point for workers on the crowdsourcing task that is only visible to members of the target audience that click on the targeted advertisement. Only members of the target audience that click on the targeted advertisement are permitted to proceed to the non-public landing page.

According to yet another aspect of the present principles, there is provided a non-transitory computer readable storage medium having computer executable code stored thereon for performing a method. The method includes defining a target audience for a crowdsourcing task using fine-grain target audience parameters. At least one of the parameters is based on a user selection. The method further includes generating a targeted advertisement for a non-public landing page directed to the target audience. The method also includes generating the non-public landing page as a sole entry point for workers on the crowdsourcing task that is only visible to members of the target audience that click on the targeted advertisement. The method additionally includes permitting only members of the target audience that click on the targeted advertisement to proceed to the non-public landing page.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 shows an exemplary system 100 for delivering video content to which the present principles may be applied, in accordance with an embodiment of the present principles;

FIG. 2 shows an exemplary processing system 200 to which the present principles may be applied, according to an embodiment of the present principles, is shown;

FIG. 3 shows an exemplary system 300 for targeted crowdsourcing, in accordance with an embodiment of the present principles;

FIG. 4 shows an exemplary method 400 for targeted crowdsourcing, in accordance with an embodiment of the present principles; and

FIG. 5 shows another exemplary method 500 for targeted crowdsourcing, in accordance with an embodiment of the present principles.

### DETAILED DESCRIPTION

The present principles are directed to a method and system for targeted crowdsourcing.

In an embodiment, the present principles provide a way to target a very specific population of users for crowdsourcing efforts. In an embodiment, we use the tools a social network (e.g., Facebook™) provides advertisers to target users in order to create targeted ads for crowdsourcing work, which will guarantee that those ads will only be seen (and clicked on) by a specific set of users, which in turn guarantees that only those users will be the ones carrying out the crowdsourcing work. The tools are described in further detail herein below. Of course, the present principles are not limited to the aforementioned tools and social network and, thus, other tools and social networks as well as other networks and platforms can also be used in accordance with the teachings of the present principles, while maintaining the spirit of the present principles.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Initially, a system for delivering various types of content to a user will be described.

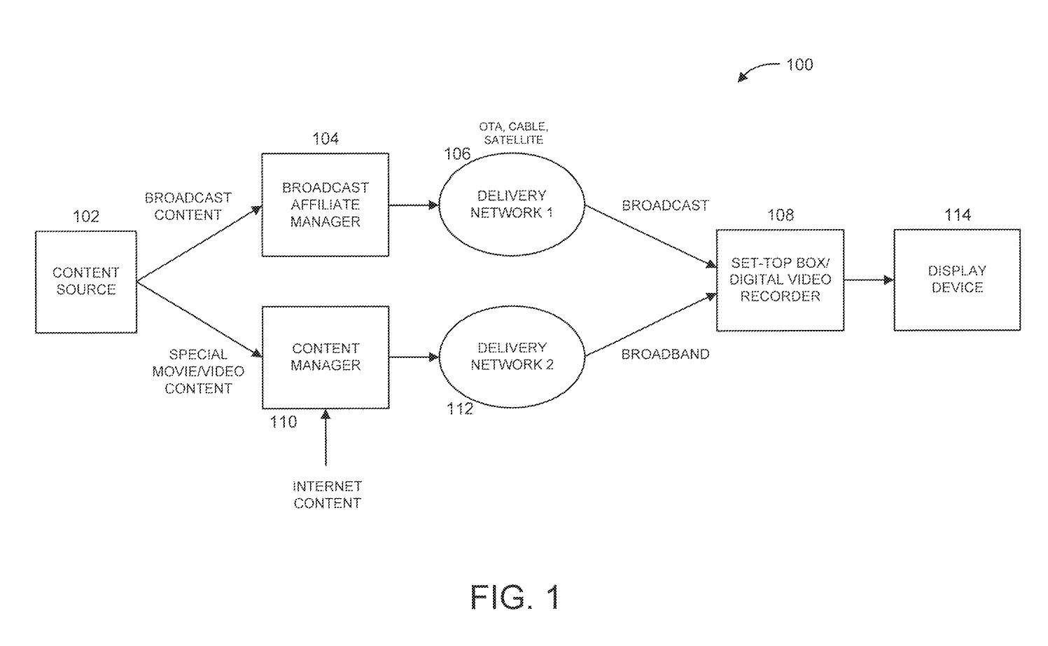

FIG. 1 shows an exemplary system 100 for delivering video content to which the present principles may be applied, in accordance with an embodiment of the present principles. The content originates from a content source 102, such as a movie studio or production house. The content may be supplied in at least one of two forms. One form may be a broadcast form of content. The broadcast content is provided to the broadcast affiliate manager 104, which is typically a national broadcast service, such as the American Broadcasting Company (ABC), National Broadcasting Company (NBC), Columbia Broadcasting System (CBS), etc. The broadcast affiliate manager may collect and store the content, and may schedule delivery of the content over a deliver network, shown as delivery network 1 (106). Delivery network 1 (106) may include satellite link transmission from a national center to one or more regional or local centers. Delivery network 1 (106) may also include local content delivery using local delivery systems such as over the air broadcast, satellite broadcast, or cable broadcast. The locally delivered content is provided to a user's set top box/digital video recorder (DVR) 108 in a user's home, where the content will form part of the results of subsequent searches by the user.

A second form of content is referred to as special content. Special content may include content that may have been delivered as premium viewing, pay-per-view, or other content otherwise not provided to the broadcast affiliate manager. In many cases, the special content may be content requested by the user. The special content may be delivered to a content manager 110. The content manager 110 may be a service provider, such as an Internet website, affiliated, for instance, with a content provider, broadcast service, or delivery network service. The content manager 110 may also incorporate Internet content into the delivery system, or explicitly into the search only such that content may be searched that has not yet been delivered to the user's set top box/digital video recorder 108. The content manager 110 may deliver the content to the user's set top box/digital video recorder 108 over a separate delivery network, delivery network 2 (112). Delivery network 2 (112) may include high-speed broadband Internet type communications systems. It is important to note that the content from the broadcast affiliate manager 104 may also be delivered using all or parts of delivery network 2 (112) and content from the content manager 110 may be delivered using all or parts of Delivery network 1 (106). In addition, the user may also obtain content directly from the Internet via delivery network 2 (112) without necessarily having the content managed by the content manager 110.

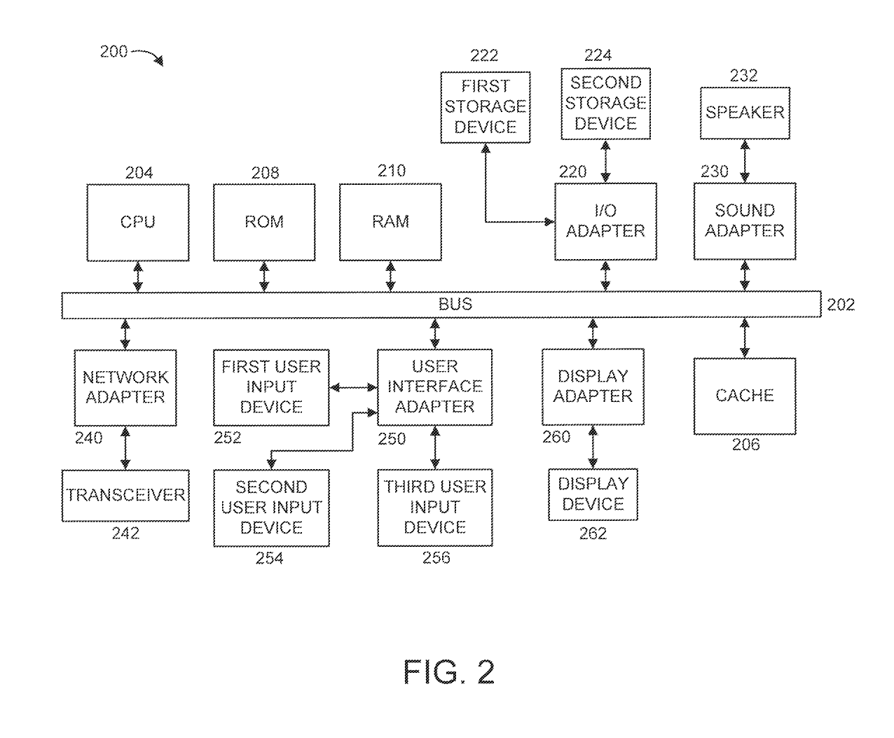

The set top box/digital video recorder 108 may receive different types of content from one or both of delivery network 1 and delivery network 2. The set top box/digital video recorder 108 processes the content, and provides a separation of the content based on user preferences and commands. The set top box/digital video recorder may also include a storage device, such as a hard drive or optical disk drive, for recording and playing back audio and video content. The processed content is provided to a display device 114. The display device 114 may be a conventional 2-D type display or may alternatively be an advanced 3-D display. It should be appreciated that other devices having display capabilities such as wireless phones, PDAs, computers, gaming platforms, remote controls, multi-media players, or the like, may employ the teachings of the present disclosure and are considered within the scope of the present disclosure. In some embodiments, at least display device 114, and in other embodiments, also set top box/digital video recorder 108, can be replaced by a processing system having a display such as processing system 200 shown and described with respect to FIG. 2. The processing system 200 can be representative of any media consumption/presentation device.

FIG. 2 shows an exemplary processing system 200 to which the present principles may be applied, according to an embodiment of the present principles, is shown. The processing system 200 includes at least one processor (CPU) 204 operatively coupled to other components via a system bus 202. A cache 206, a Read Only Memory (ROM) 208, a Random Access Memory (RAM) 210, an input/output (I/O) adapter 220, a sound adapter 230, a network adapter 240, a user interface adapter 250, and a display adapter 260, are operatively coupled to the system bus 202.

A first storage device 222 and a second storage device 224 are operatively coupled to system bus 202 by the I/O adapter 220. The storage devices 222 and 224 can be any of a disk storage device (e.g., a magnetic or optical disk storage device), a solid state magnetic device, and so forth. The storage devices 222 and 224 can be the same type of storage device or different types of storage devices.

A speaker 232 is operative coupled to system bus 202 by the sound adapter 230.

A transceiver 242 is operatively coupled to system bus 202 by network adapter 240.

A first user input device 252, a second user input device 254, and a third user input device 256 are operatively coupled to system bus 202 by user interface adapter 250. The user input devices 252, 254, and 256 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 252, 254, and 256 can be the same type of user input device or different types of user input devices. The user input devices 252, 254, and 256 are used to input and output information to and from system 200.

A display device 262 is operatively coupled to system bus 202 by display adapter 260.

Of course, the processing system 200 may also include other elements (not shown), as readily contemplated by one of skill in the art, as well as omit certain elements. For example, various other input devices and/or output devices can be included in processing system 200, depending upon the particular implementation of the same, as readily understood by one of ordinary skill in the art. For example, various types of wireless and/or wired input and/or output devices can be used.

Moreover, additional processors, controllers, memories, and so forth, in various configurations can also be utilized as readily appreciated by one of ordinary skill in the art. These and other variations of the processing system 200 are readily contemplated by one of ordinary skill in the art given the teachings of the present principles provided herein.

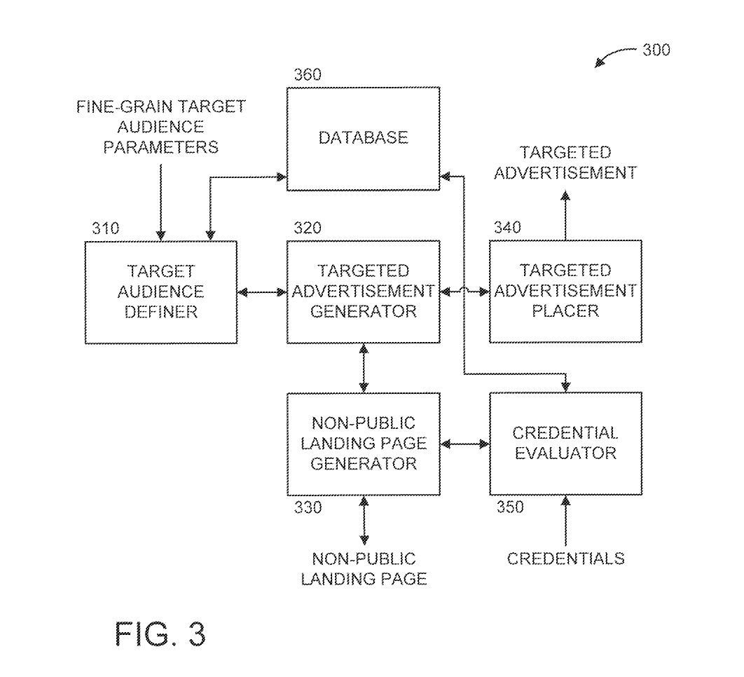

Moreover, it is to be appreciated that system 300 described below with respect to FIG. 3 is a system for implementing respective embodiments of the present principles. Part or all of processing system 200 may be implemented in one or more of the elements of system 300.

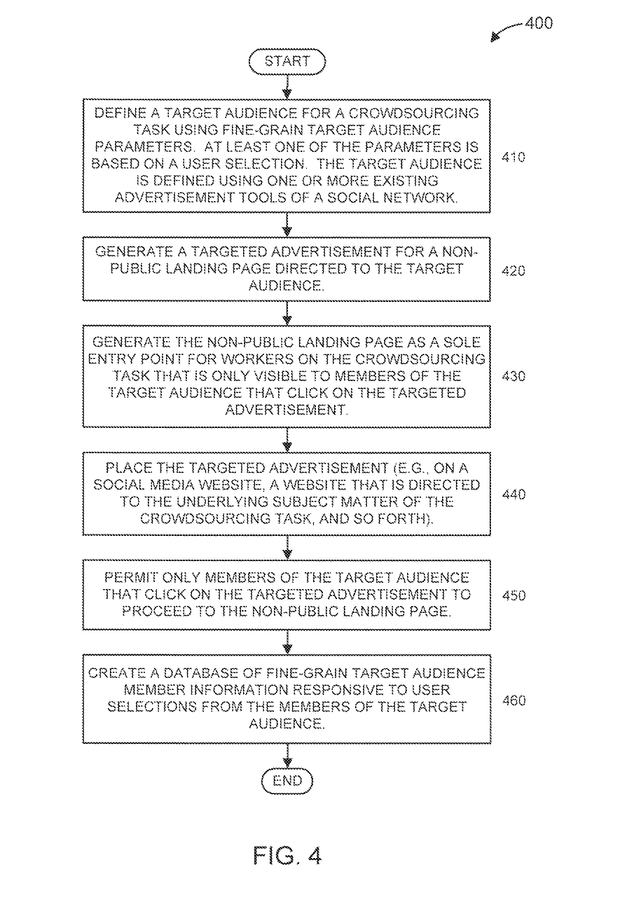

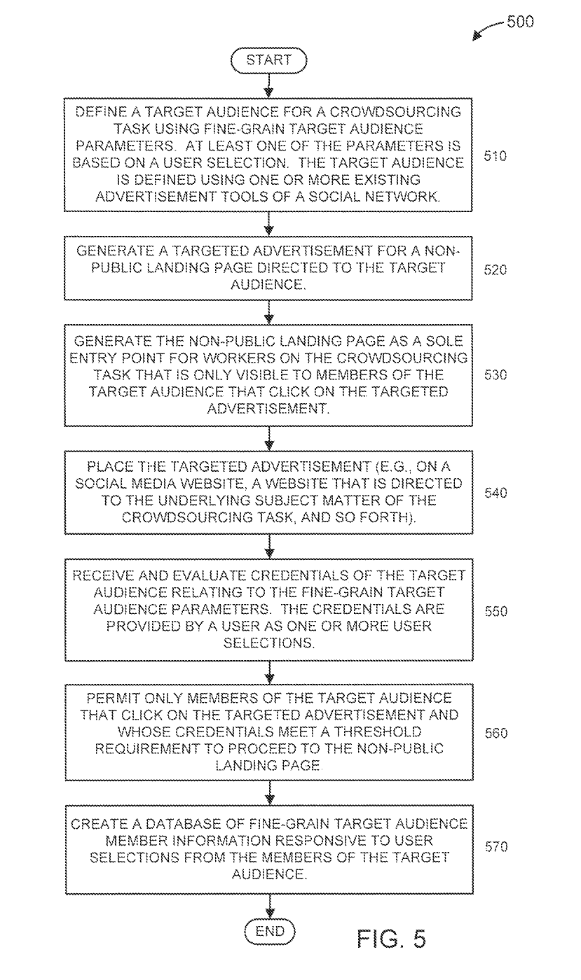

Further, it is to be appreciated that processing system 200 may perform at least part of the method described herein including, for example, at least part of method 400 of FIG. 4 and/or at least part of method 500 of FIG. 5. Similarly, part or all of system 300 may be used to perform at least part of method 400 of FIG. 4 and/or at least part of method 500 of FIG. 5.

FIG. 3 shows an exemplary system 300 for targeted crowdsourcing, in accordance with an embodiment of the present principles. The system 300 includes a target audience definer 310, a targeted advertisement generator 320, a non-public landing page generator 330, a targeted advertisement placer 340, a credential evaluator 350, and a database of fine-grain target audience member information 360.

The target audience definer 310 defines a target audience for a crowdsourcing task using fine-grain target audience parameters. At least one of the parameters is based on a user selection. In an embodiment, the target audience is defined using one or more existing advertisement tools of a social network.

The targeted advertisement generator 320 generates a targeted advertisement for a non-public landing page directed to the target audience.

The non-public landing page generator 330 generates the non-public landing page. In an embodiment, the non-public landing page is the sole entry point for workers on the crowdsourcing task and is only visible to members of the target audience that click on the targeted advertisement. In an embodiment, only members of the target audience that click on the targeted advertisement are permitted to proceed to the non-public landing page.

The targeted advertisement placer 340 places the targeted advertisement. In an embodiment, the targeted advertisement is placed on a social network. In an embodiment, the targeted advertisement is placed on a website that is directed to the underlying subject matter of the crowdsourcing task. In an embodiment, the targeted advertisement placer 340 is connected to one or more networks that are used to place the targeted advertisement. The preceding placement locations are provided for illustrative purposes and, thus, other placement locations can also be used.

The credential evaluator 350 receives and evaluates credentials of the target audience relating to the fine-grain target audience parameters. In an embodiment, only the members of the target audience whose credentials meet a threshold requirement are permitted to view the advertisement and click on the advertisement.

In an embodiment, the credentials are provided by a user as one or more user selections. Of course, other forms of credentials can also be used.

The database 360 stores fine-grain target audience member information created responsive to user selections from the members of the target audience. This information can then be used for other target advertisements in order to ensure that only a particular audience can see and act upon the landing page for a crowdsourcing task.

One or more of the elements of system 300 are shown receiving inputs or providing outputs. Such inputs and outputs can be respectively received and provided locally or remotely with respect to system 300. In an embodiment relating to the former case (locally received inputs and locally provided outputs), the relevant elements or the system 300 itself can include hardware for facilitating the same such as a keyboard, keypad, mouse, speech recognition system, a display screen, and so forth as readily appreciated by one of ordinary skill in the art. In the latter case (remotely received inputs and remotely provided outputs), the relevant elements or the system 300 itself can include hardware for facilitating the same such as a transceiver, a network adapter, and so forth as readily appreciated by one of ordinary skill in the art. These and other variations of the elements of FIG. 3 are readily determined by one of ordinary skill in the art, given the teachings of the present principles provided herein, while maintaining the spirit of the present principles.

FIG. 4 shows an exemplary method 400 for targeted crowdsourcing, in accordance with an embodiment of the present principles.

At step 410, define a target audience for a crowdsourcing task using fine-grain target audience parameters. At least one of the parameters is based on a user selection. In an embodiment, the target audience is defined using one or more existing advertisement tools of a social network.

At step 420, generate a targeted advertisement for a non-public landing page directed to the target audience.

At step 430, generate the non-public landing page as a sole entry point for workers on the crowdsourcing task that is only visible to members of the target audience that click on the targeted advertisement.

At step 440, place (that is, publish and/or otherwise make public) the targeted advertisement. For example, in an embodiment, the targeted advertisement can be placed on a social media website, and/or on a website that is directed to the underlying subject matter of the crowdsourcing task and/or so forth.

At step 450, permit only members of the target audience that click on the targeted advertisement to proceed to the non-public landing page. At step 460, create a database of fine-grain target audience member information responsive to user selections from the members of the target audience.

FIG. 5 shows another exemplary method 4500 for targeted crowdsourcing, in accordance with an embodiment of the present principles.

At step 510, define a target audience for a crowdsourcing task using fine-grain target audience parameters, at least one of the parameters based on a user selection. In an embodiment, the target audience is defined using one or more existing advertisement tools of a social network.

At step 520, generate a targeted advertisement for a non-public landing page directed to the target audience.

At step 530, generate the non-public landing page as a sole entry point for workers on the crowdsourcing task that is only visible to members of the target audience that click on the targeted advertisement.

At step 540, place (that is, publish and/or otherwise make public) the targeted advertisement. For example, in an embodiment, the targeted advertisement can be placed on a social media website, and/or on a website that is directed to the underlying subject matter of the crowdsourcing task and/or so forth.

At step 560, receive and evaluate credentials of the target audience relating to the fine-grain target audience parameters. In an embodiment, the credentials are provided by a user as one or more user selections.

At step 570, permit only members of the target audience that click on the targeted advertisement and whose credentials meet a threshold requirement to proceed to the non-public landing page.

At step 580, create a database of fine-grain target audience member information responsive to user selections from the members of the target audience.

In an embodiment, the present principles involve using existing user targeting techniques and tools, in particular ad targeting techniques and tools, in order to control the population used in crowdsourcing activities.

A description will now be provided of a simple targeted crowdsourcing example, in accordance with an embodiment of the present principles. As noted above, Amazon Mechanical Turk™ (AMT) is a very common platform for crowdsourcing. Companies use AMT, for example, to get feedback on different items and designs. However, one key problem is that we do not know anything or much about the AMT users (what Amazon™ calls Mechanical Turk Workers or MTWs) who provide the feedback. For example, are the MTWs mostly male or female, what age, what background, where do they live, and so forth. Clearly, knowing more about the MTWs would be very valuable to interpret the data and feedback generated by the MTWs. Better yet, being able to target a specific kind of MTW would be even more valuable. For example, it would be advantageous to be able to submit a request to AMT for a MTW of a specific gender, age, zip code, activity level on Facebook™, and so forth.

Accordingly, the present principles provide a solution to the problem of targeting a specific set of MTW or crowdsourcing participants in general. In an embodiment, we use targeted ads to advertise crowdsourcing work and filter the audience that will be able to see and reply to the ads, then lead that audience to a web page that is only visible by that audience and which would be the starting web page for the crowdsourcing work. That is, the web page is invisible to the outside world (it has a non-public universal resource locator (URL)) so “random” MTWs will not stumble upon the web page. In an embodiment, we use Facebook™ advertisements since they provide very fine-grained tools to target an audience. Thus, in an embodiment, we can the starting page the landing page of a Facebook™ advertisement campaign. Of course, other networks and so forth can also be used in accordance with the teachings of the present principles, while maintaining the spirit of the present principles.

For example, we will now provide a targeted crowdsourcing example with respect to Linkedin™, in accordance with an embodiment of the present principles. For a targeted advertisement on Linkedin™, it would be advantageous to be able to filter the audience according to their specific skills (for example, experts in data mining, or image processing, or channel marketing, etc.) or career path (for example, people who have spent their career in startups, etc.) or position (for example, vice president level or above, research scientist, etc.). Facebook does not allow the preceding level of specificity. However, filtering by skills and so forth can be extremely useful for many crowdsourcing tasks.

It is not possible right now to filter the contributors to an AMT task to a level as described herein. Accordingly, in this sense, the conventional approach is coarse-grained. In contrast, as used herein with respect to a target audience, the term “fine-grain” represents as applied thereto refers to allowing for the identification of a very specific, well identified subset of the general population. For example, a Facebook™ advertisement allows a person placing the advertisement to specify that the advertisement is only shown to users with the following characteristics: male, between 18 and 25, live in a particular state, with a specific relationship status, with at least a certain number of friends, who “Liked” this specific brand, and so forth. In other words, the Facebook™ advertisement lets the user specify the characteristics of the target audience down to a very detailed level. A coarse-grained specification would not include this fine level of detail, and instead would rely on smoothed or averaged descriptions. Taking the example of Linkedin™ described herein before, a fine-grained approach would allow the user to specifically target “currently employed, women, currently working or who worked in the past at this specific company, Director level or above”, whereas a coarse grained approach would just specify “employed” or “woman”.

One of the examples above uses Facebook™ advertisements for at least the following three reasons. One reason is that Facebook™ provides fine-grained targeting abilities. Another reason is that Facebook™ covers much of the human population worldwide. Yet another reason is that a Facebook™ advertisement campaign naturally leads people who click on advertisements to a landing page. However, while one or more embodiments of the present principles are described with respect to Facebook™, it is to be appreciated that the present principles can be used in other environments (including other social networks, non-social network environments, and so forth). That is, given the teachings of the present principles provided herein, one of ordinary skill in the art will contemplate the preceding environment as well as other environments to which the present principles can be applied, while maintaining the spirit of the present principles.

A description will now be given of an example of targeted crowdsourcing, in accordance with an embodiment of the present principles.

In the example, we create a targeted advertisement (e.g., on Facebook™) for a (landing) page. To that end, we define a target audience using (e.g., Facebook™) targeting options (including, but not limited to, location, age, interests, education, and connections), and create the advertisement with a click leading to a non-public landing page (meaning that the URL is not public, only seen by users after they click on the advertisement).

Moreover, in the example, we make that landing page be the starting page for the proposed crowdsourcing proposal.

Thus, the present principles advantageously combine user selection (e.g., with Facebook™ or another platform) using targeted advertising for a landing page, with that page being the entry point for the crowdsourcing work.

A description will now be given of some of the many attendant advantages of the present principles. The present principles offer crowdsourcing jobs where only a target population with specific characteristics will participate in the crowdsourcing effort. The present principles are easy to implement, e.g., on Facebook™ Mechanical Turk, and so forth. The present principles are easy to extend to other crowdsourcing environments. The present principles take advantage of expected continuous improvements in (Facebook™ or other platform) targeting abilities.

While some of the examples provided herein involve Facebook™ and AMT, the present principles apply to other targeting mechanisms such as those provided by Google™, Bing™, Linkedin™, and others. Furthermore, the present principles apply to other crowdsourcing platforms such as, but not limited to, CrowdFlower™ and so forth.

Here is one possible example in a completely different scenario than the Facebook™ and AMT scenario so far described. In this example, we create targeted advertisements on certain websites, including but not limited to computer programming question and answer websites visited by programmers and testers (including, but not limited to, Stackoverflow and so forth), information technology (IT) security and hacking news source websites visited by information technology interested individuals, security specialists, and hackers (including, but not limited to, Hackernews and so forth) in order to select coders for code review or debugging, in order to develop a targeted and effective “testing as a service” platform. Other websites relating to a different target audience can be used to target that audience for crowdsourcing purposes in accordance with the present principles.

A description will now be given of some of the many attendant advantages/features of the present invention, some of which have been mentioned above. For example, one advantage/feature is a method that includes defining a target audience for a crowdsourcing task using fine-grain target audience parameters. At least one of the parameters is based on a user selection. The method further includes generating a targeted advertisement for a non-public landing page directed to the target audience. The method also includes generating the non-public landing page as a sole entry point for workers on the crowdsourcing task that is only visible to members of the target audience that click on the targeted advertisement. The method additionally includes permitting only members of the target audience that click on the targeted advertisement to proceed to the non-public landing page.

Another advantage/feature is the method as described above, further including receiving and evaluating credentials of the target audience relating to the fine-grain target audience parameters. Only the members of the target audience whose credentials meet a threshold requirement are permitted to view the advertisement and click on the advertisement.

Yet another advantage/feature is the method as described above, wherein the credentials are provided by a user as one or more user selections.

Still another advantage/feature is the method as described above, further including creating a database of fine-grain target audience member information responsive to user selections from the members of the target audience.

Moreover, another advantage/feature is the method as described above, further including placing the targeted advertisement on a social network.

Further, another advantage/feature is the further including placing the targeted advertisement on a social network as described above, wherein the defining step is performed using one or more existing advertisement tools of the social network.

Also, another advantage/feature is the method as described above, further including placing the targeted advertisement on a website that is directed to an underlying subject matter of the crowdsourcing task.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. A method comprising:
defining a target audience for a crowdsourcing task using fine-grain target audience parameters, at least one of the parameters based on a user selection;
generating a targeted advertisement for a non-public landing page directed to the target audience;
generating the non-public landing page as a sole entry point for workers on the crowdsourcing task that is only visible to members of the target audience that click on the targeted advertisement; and
permitting only members of the target audience that click on the targeted advertisement to proceed to the non-public landing page.

2. The method of claim 1, further comprising receiving and evaluating credentials of the target audience relating to the fine-grain target audience parameters, and wherein only the members of the target audience whose credentials meet a threshold requirement are permitted to view the advertisement and click on the advertisement.

3. The method of claim 1, wherein the credentials are provided by a user as one or more user selections.

4. The method of claim 1, further comprising creating a database of fine-grain target audience member information responsive to user selections from the members of the target audience.

5. The method of claim 1, further comprising placing the targeted advertisement on a social network.

6. The method of claim 5, wherein the defining step is performed using one or more existing advertisement tools of the social network.

7. The method of claim 1, further comprising placing the targeted advertisement on a website that is directed to an underlying subject matter of the crowdsourcing task.

8. A system comprising:
a target audience definer for defining a target audience for a crowdsourcing task using fine-grain target audience parameters, at least one of the parameters based on a user selection;
a targeted advertisement generator for generating a targeted advertisement for a non-public landing page directed to the target audience; and
a non-public landing page generator for generating the non-public landing page as a sole entry point for workers on the crowdsourcing task that is only visible to members of the target audience that click on the targeted advertisement,
wherein only members of the target audience that click on the targeted advertisement are permitted to proceed to the non-public landing page.

9. The system of claim 8, further comprising a credential evaluator for receiving and evaluating credentials of the target audience relating to the fine-grain target audience parameters, and wherein only the members of the target audience whose credentials meet a threshold requirement are permitted to view the advertisement and click on the advertisement.

10. The system of claim 8, wherein the credentials are provided by a user as one or more user selections.

11. The system of claim 8, further comprising a database of fine-grain target audience member information created responsive to user selections from the members of the target audience.

12. The system of claim 8, wherein the targeted advertisement is placed on a social network.

13. The system of claim 12, wherein the target audience is defined using one or more existing advertisement tools of the social network.

14. The system of claim 8, further comprising a targeted advertisement placer for placing the targeted advertisement on a website that is directed to an underlying subject matter of the crowdsourcing task.

15. A non-transitory computer readable storage medium having computer executable code stored thereon for performing a method, the method comprising:
defining a target audience for a crowdsourcing task using fine-grain target audience parameters, at least one of the parameters based on a user selection;
generating a targeted advertisement for a non-public landing page directed to the target audience;
generating the non-public landing page as a sole entry point for workers on the crowdsourcing task that is only visible to members of the target audience that click on the targeted advertisement; and
permitting only members of the target audience that click on the targeted advertisement to proceed to the non-public landing page.
